(19) United States
(12) Patent Application Publication
(10) Pub. No.: US 2008/0168493 A1
(43) Pub. Date: Jul. 10, 2008

(54) Mixing User-Specified Graphics with Video Streams

(76) Inventors: James Jeffrey Allen, San Mateo, CA (US); David Adams, Palo Alto, CA (US); Philippe Roger, Los Gatos, CA (US)

Correspondence Address: BUTZER & CHEN LAW, LLC, 870 HIGH STREET, SUITE 104, WORTHINGTON, OH, 43085, US

(21) Appl. No.: 11/959,693

(22) Filed: Dec. 19, 2007

Related U.S. Application Data
(60) Provisional application No. 60/883,906, filed on Jan. 8, 2007.
(60) Provisional application No. 60/955,861, filed on Aug. 14, 2007.
(60) Provisional application No. 60/955,865, filed on Aug. 14, 2007.

(51) Int. Cl. H04N 5/445; G09G 5/00

(52) U.S. Cl. 725/37; 345/619

(57) ABSTRACT

A method that includes steps of providing an interface that permits a user to at least partially specify an appearance and content of graphics, generating the graphics, accessing a video stream, mixing the graphics with the video stream without changing a size and aspect ratio of the video stream, and presenting the graphics mixed with the video stream to the user on an end-user device. Also, devices that implement the method and associated uses and techniques.

### CROSS REFERENCE TO RELATED APPLICATION

This application claims priority from provisional application No. 60/883,906, titled “Alpha-blending user-defined interactive applications with video streams,” in the names of James J. Allen, David Adams, and Philippe Roger, filed Jan. 8, 2007; from provisional application No. 60/955,861, titled “Attaching ‘Widgets’ to Video,” in the names of the same inventors, filed Aug. 14, 2007; and from provisional application No. 60/955,865, titled “Attaching ‘Widgets’ to Pre-Existing Video and Broadcast Streams,” filed Aug. 14, 2007, in the names of the same inventors.

### FIELD OF THE INVENTION

This invention relates to techniques that provide an interactive experience to viewers of video streams by mixing user-specified graphics with the video streams.

### BACKGROUND OF THE INVENTION

Computer programs, cable network systems, set-top box components, mobile phone applications and interactive television systems often provide an ability to combine graphics with a video stream such as a cable or television broadcast. For example, a settings menu or graphic can be accessed to set contrast, brightness, volume, and/or other viewing properties. For another example, an interactive television program guide can be accessed. In these examples, the associated graphics usually are either overlaid opaquely or semi-transparently over a currently displayed video stream or the video stream is “squeezed” into a corner to make room for those graphics. In these examples, the appearance and content of the graphics are defined by a content or equipment provider.

Skilled programmers also can overlay or alpha-blend coded graphics with video streams, for example for special effects.

Some attempts have been made to provide interactive television that presents provider-defined graphics to a user overlaid on a video stream, for example to permit voting.

Efforts are also underway to provide “enhanced TV.” These efforts often involve a two-screen solution, where one screen is a television and the other is a personal computer or similar device. In these systems, existing cable, satellite, broadcast or IPTV infrastructure provides the broadcast video, and information related to the television screen is provided through a separate computer or device not connected to the television. In these systems, information input through the personal computer or similar device may affect calls to action in the broadcast such as a vote, resulting in the broadcast to display new video and associated graphics, such as vote results. In these solutions, input through the personal computer or similar device might affect functions of the television display device such as channel selection.

### SUMMARY OF THE INVENTION

What is needed for an enhanced entertainment experience is a way for a user to at least partially specify an appearance and select user-specific content for graphics to be mixed with a video stream (possibly accompanied by audio). This would permit a user to personalize what graphics they see, how they see them, and display content that is specific to their own personal tastes.

For example, a user might want to view personal fantasy game statistics while watching a sports television broadcast (in contrast to fantasy game statistics that the broadcaster might provide to the general audience of television viewers). One user might want to view his or her personal game statistics through a small “ticker” at the top of a full-screen broadcast using a 50% transparency level, whereas a different user might want to view his or her personal game statistics (which are different than the first user's statistics) through an alert “box” at the bottom left hand portion of the screen using an 80% transparency level. Or each user may decide to change their mind and have the personal game statistics displayed using a different graphical user interface—or skin—and/or want to also move the application from one location to another and/or change the transparency ratio between the video stream and the application, and/or change the location of the application “on the fly” using an input device.

In this example, a user might want to keep the graphics/application displayed, but change the television channel or video source at anytime without affecting the graphics/application.

Other desired types of personalized actions that users might want perform while watching full-motion video include viewing multimedia retrieved from data providers, business servers or other user's computers. Examples include personal stock portfolio positions and prices, personal calendar or event alerts, personalized sports game statistics, other users' photos, other users' videos, and the like. Other desired types of personalized activities include interacting with other users, such as voting on issues related to a web-based video or television broadcast, chatting with other users watching the broadcast, making wagers with other users, listening to alternative audio streams; watching complementary video streams or personalized commentary; and the like.

In order to help preserve the entertainment value of the video stream itself, the video stream preferably retains its size and aspect ratio when mixed with the graphics, or at least 75% of its size and aspect ratio when mixed with the graphics.

The invention addresses this need through methods that include the steps of providing an interface that permits a user to at least partially specify an appearance and content of graphics, generating the graphics, accessing a video stream (possibly with audio), mixing the graphics with the video stream without changing a size and aspect ratio of the video stream, and presenting the graphics mixed with the video stream to the user on an end-user device.

In a preferred embodiment, the graphics are buffered in an application graphics buffer, and the video stream is buffered in a video buffer. This arrangement facilitates mixing of the graphics with the video stream, for example through alpha-blending.

The graphics can include virtually anything specified by the user, for example but not limited to one or more of data to be presented to the user, text, images, animation sequences, videos, video frames, tickers, static control features, interactive control features, or some combination thereof.

In a preferred embodiment, a collection of information describing a set of graphics, called a “skin,” can be selected through the interface. This facilitates ease of use. The skin preferably can be selected from a library of skins that includes skins developed by people other than the user. Thus, users can share skins, and each user need not fully define their own skin(s). Of course, a user could fully define their own personal skin if they want to do so. The skins preferably are editable or customizable, further enhancing personalization of the entertainment experience.

The appearance, the content, or the appearance and the content of the graphics preferably can be changed in real time by the user and/or (if the user permits) by another person. For example, a user might change these aspects of the graphics depending on the type of video stream they are viewing (e.g., sports, news, gaming, shopping, personal time management, etc.), and other users might be able to “push” graphics to another user in response to some event (e.g., an animation related to one team scoring in a sports event).

Changes to the graphics that are possible preferably include at least making at least a portion of the graphics disappear or appear, moving at least a portion of the graphics, and changing a transparency level of at least a portion of the graphics. Other changes are possible.

The graphics also preferably can be specified to be responsive to non-video and non-audio data contained in the video stream. For example, the graphics could be responsive to data in closed captioning, subtitles, or other streamed types of meta-data associated with a video stream. The graphics also preferably can be specified to be responsive to a source different from the video stream. For example, the graphics could be responsive to a different channel than that for the video stream, a local network, a remote network, the Internet, a wireless network, or some combination thereof.

The graphics need not be related to a specific video stream. For one example, the graphics could be one or more notes defined by a user that appear as sticky-notes, with the notes or presentation of the notes responsive to a date, time, or calendar. For another example, the graphics could be an associated application programming guide that provides suggestions of one or more applications to generate at least part of the graphics.

The various foregoing example are illustrative only. The invention is not limited to these examples. The invention also encompasses methods of using (from a user's perspective) the invention and devices that implement the invention.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWING FIGURES

FIG. 1 shows one possible architecture for an embodiment of the invention.

FIG. 2 shows one possible method for implementing an embodiment of the invention.

FIG. 3 shows one possible method for using an embodiment of the invention.

FIG. 4 shows mixing of frames according to an embodiment of the invention.

### DESCRIPTION OF PREFERRED EMBODIMENTS

Incorporated Applications

The following applications are hereby incorporated by reference as if fully set forth herein:
provisional application No. 60/883,906, titled “Alpha-blending user-defined interactive applications with video streams,” in the names of James J. Allen, David Adams, and Philippe Roger, same inventors, filed Jan. 8, 2007;
provisional application No. 60/955,861, titled “Attaching ‘Widgets’ to Video,” in the names of the same inventors, filed Aug. 14, 2007; and
provisional application No. 60/955,865, titled “Attaching ‘Widgets’ to Pre-Existing Video and Broadcast Streams,” filed Aug. 14, 2007, in the names of the same inventors.

These documents are referred to as the “Incorporated Disclosures” in this application.

Architecture

Briefly, one possible architecture for an embodiment of the invention includes a processor and memory that executes an application to provide an interface that permits a user to at least partially specify an appearance and content of graphics and to generate the graphics, an interface to a video stream, an application graphics buffer that buffers the graphics, a video buffer that buffers the video stream, a mixer that mixes outputs from the application graphics buffer and the video buffer without changing a size and aspect ratio of the video stream, and an interface to an end-user device for presentation of the graphics mixed with the video stream to the user.

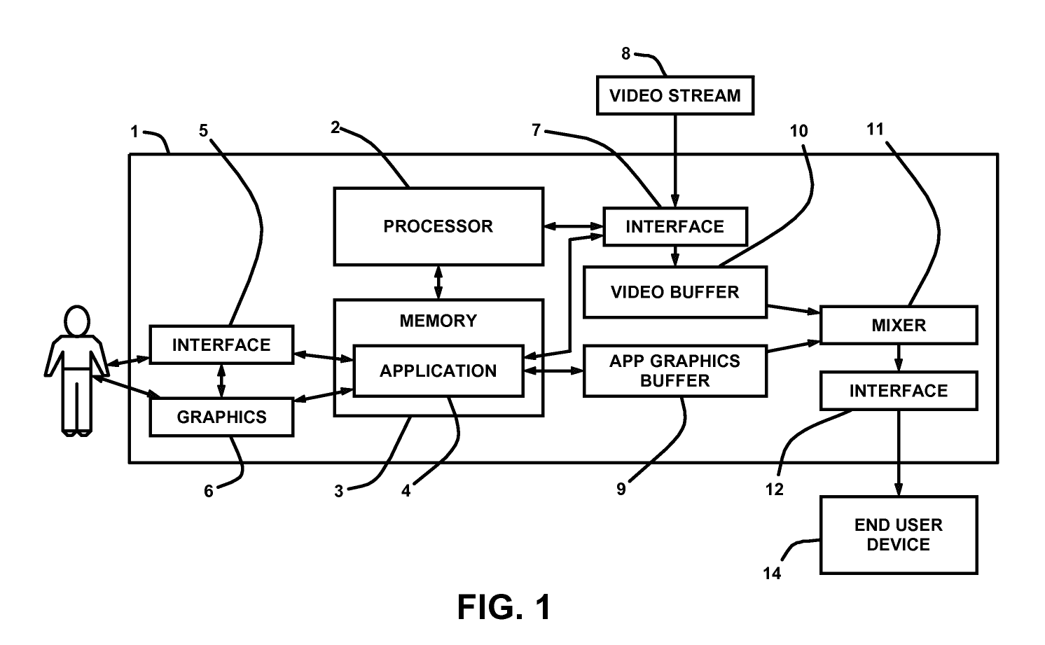

In more detail, FIG. 1 is a block diagram showing system 1 that includes processor 2 and memory 3 that operate together to execute application 4. This application provides interface 5 that permits a user to at least partially specify an appearance and content of graphics 6 and to generate the graphics. The system also includes interface 7 to video stream 8. Application graphics buffer 9 buffers the graphics, and video buffer 10 buffers the video stream. Mixer 11 mixes outputs from the application graphics buffer and the video buffer, preferably without changing a size and aspect ratio of the video stream. (In alternative embodiments, the size and aspect ratio can be changed, but preferably at least 75% of the video stream's size and aspect ratio is preserved.) Interface 12 is provided for connection to end-user device 14 for presentation of the graphics mixed with the video stream to the user.

System 1 can be implemented as hardware, firmware, software, or some combination thereof. The system can be or can be part of a wide variety of devices or systems, for example but not limited to a set-top box, game consol, dongle, television, personal computer, web computer, server, chipset, or any other types of processing or computing devices. While the elements of system 1 are shown in one block diagram, the elements need not be physically or logically local to each other. For example, parts of the system could reside in a set-top box or television, with other parts of the system residing on a web server.

Processor 2 can be any type of processor or processors capable of executing operations to carry out the invention, including but not limited to one or more CPUs, dedicated hardware, ASICs, or the like. Memory 3 can be any type of memory capable of storing instructions and/or information for carrying out the invention, including but not limited to RAM, ROM, EPROM, storage devices, storage media, or the like.

Application 4 can be any set of instructions or operations for carrying out the invention, including but not limited to software, firmware, instructions reduced to hardware, or the like.

Interface 5 is provided by or operates with application 4 to permit a user to at least partially specify an appearance and content of graphics 6. Interface 5 can be any type of interface that permits user input to specify, generate, and/or edit an appearance or content of graphics 6, either directly or through one or more other interfaces, devices, or systems. Examples include but are not limited to a personal computer, web computer, server, cell phone, PDA, web site, file space, user profile, remote control, keyboard, mouse, storage, graphics or video editing tool, special effects editing tool, an interface to any of these, or some combination thereof.

Graphics 6 can include one or more of data to be presented to a user, text, text boxes, images, animation sequences, videos, video frames, tickers, static control features, interactive control features, other graphics elements, or some combination thereof. Examples of control features include but are not limited to score boards, score tickers, stock tickers, news tickers, control slides, bars, dials and the like, user-to-user and group chats, shopping aids, bid trackers, and the like.

In a preferred embodiment, control features (and possibly other features) in graphics 6 become or interoperate with parts of interface 5. Thus, graphics 6 themselves preferably can further permit a user to at least partially specify an appearance and content of the graphics.

A set of graphics 6 called a “skin” can be described by a collection of information that preferably can be shared, uploaded, and/or downloaded, thereby facilitating user specification and selection of graphics that they want to see.

The appearance, the content, or the appearance and the content of graphics 6 can be responsive to video and/or audio of a video stream with which they will be mixed. Alternatively, the graphics can be responsive to non-video and non-audio data contained in the video stream, for example closed captioning data, or to a source different from the video stream, for example a different channel than that for the video stream, a local network, a remote network, the Internet, a wireless network, or some combination thereof In other embodiments, the graphics can be independent of such other data, for example taking the form of notes, comments, and the like entered by the user or another user, or the form of an associated application programming guide that provides suggestions of one or more applications to generate at least part of the graphics.

The graphics also can affect the nature or source of the video stream with which they will be mixed. For example, graphics in the form of a associated application programming guide can affect a source or channel for the video stream.

Interface 7 can be any interface to a video stream or a source of video stream 8, possibly accompanied by other type of data (e.g., audio, closed captioning, time stamps, watermarks, etc.). Examples of interface 7 include, but are not limited to, an interface to a television, cable or satellite broadcast, a DVD, HD-DVD, Blu-Ray® or CD-ROM player, a VCR, a computer file, a web broadcast, a web page, or the like. Examples of video stream 8 include, but are not limited to, a television, cable, or satellite broadcast, a DVD, HD-DVD, Blu-Ray®, CM-ROM or VCR movie or other recording, a computer file, a web broadcast, a web page, or the like.

Application graphics buffer 9 can be any type of buffer for graphics 6, preferably a single or multi page or frame buffer memory.

Video buffer 10 can be any type of buffer for video stream 8, also preferably a single or multi page or frame buffer memory.

Mixer 11 can be any type of hardware, software, and/or firmware that can mix outputs from application graphics buffer 9 and video buffer 10. Mixer 11 can be implemented by or be part of processor 3, memory 4, and/or application 5. Alternatively, mixer 11 can be separate from these elements. Mixing by mixer 11 preferably is through alpha-blending, although this need not be the case.

Interface 12 can be any type of interface to end-user device 14 or to another interface, device, or system that in turn can communicate with an end-user device. The end-user device can be any device or system capable of displaying a video stream (mixed with graphics according to the invention). Example of interface 12 include, but are not limited to, a co-axial interface, HDTV interface, component video or audio/video interface, HDMI interface, WiFi interface, internet interface, storage (including memory and/or removable media such as a DVD or CD-ROM), or the like. Examples of end-user device 14 include, but are not limited to, a television, monitor, personal computer, web computer, multifunction cellular phone, personal data assistant, VCR, DVD player, car-mounted video display (such as for a car-mounted DVD player or GPS system), web site, storage (including memory and/or removable media such as a DVD or CD-ROM), or the like.

The foregoing architecture is sufficient for performing the methods of the invention described below. However, the invention is not limited to this architecture and can be performed by systems that have a different architecture.

Method of Operation

Briefly, one possible method for implementing an embodiment of the invention includes the steps of providing an interface that permits a user to at least partially specify an appearance and content of graphics, generating the graphics, accessing a video stream, mixing the graphics with the video stream without changing a size and aspect ratio of the video stream, and presenting the graphics mixed with the video stream to the user on an end-user device. Preferably, the graphics are buffered in an application graphics buffer, the video stream is buffered in a video buffer, and mixing the graphics with the video stream is performed by mixing outputs from the application graphics buffer and the video buffer. The method also preferably includes the step of permitting changes to the appearance, the content, or the appearance and the content of the graphics in real time.

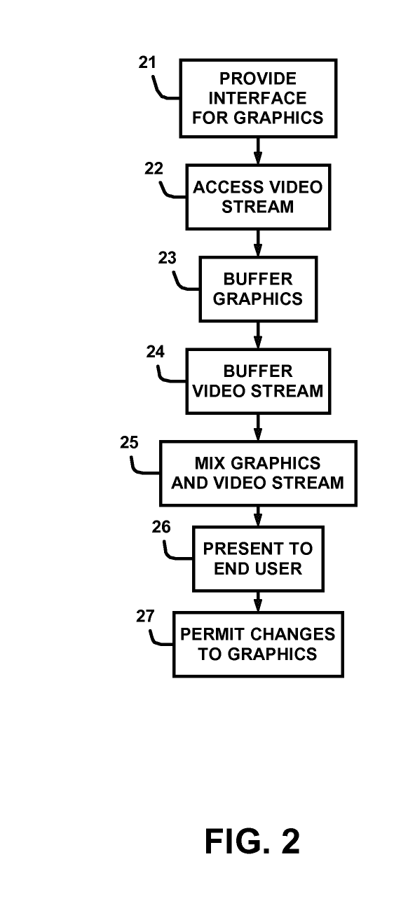

In more detail, FIG. 2 is a flowchart illustrating this method and some possible details for carrying out the method.

In step 21, an interface is provided to a user that permits the user to at least partially specify an appearance and content of graphics. Through use of the interface, the user can at least partially specify the appearance and content of the graphics for mixing with a video stream without actually having to code or to edit the graphics into the video stream.

The graphics preferably can be specified by selection of a skin through the interface. In a preferred embodiment, the skin can be selected from a library of skins that includes skins developed by people other than the user. This library preferably can be accessed online, either directly through an end-user device or indirectly such as through accessing a website that permits skin selection by the user. Alternatively, each element of the graphics can be individually specified.

One characteristic of the graphics that the user preferably can specify is a transparency level for the graphics when mixed with a video stream. Preferably, the transparency level can range from transparent (i.e., hidden) to opaque or nearly opaque.

In some embodiments, step 21 permits one user to at least partially specify an appearance, content, or appearance and content of graphics to be mixed with a video stream for viewing by another user. For example, one user might specify an animation to be displayed on another user's end-user device. For another example, one user might specify text (e.g., in a chat context) to be displayed on another user's end user device. Preferably, part of step 21 also includes each user specifying which other users can so specify graphics for display on their own end user device.

A video stream is accessed in step 22.

The graphics as (at least partially) specified by the user are buffered in an application graphics buffer in step 23. The video stream is buffered in a video buffer (possibly along with audio and/or other information that accompanies the video stream) in step 24.

In step 25, the graphics and the video stream are mixed by mixing outputs from the application graphics buffer and the video buffer. Preferably, mixing is through alpha-blending, although this need not be the case.

In alternative embodiments of the invention, different steps than steps 24 to 25 using different elements, systems, or techniques can be used to mix graphics with a video stream.

The graphics mixed with the video stream are presented to the user on an end-user device in step 26.

Step 27 permits a user to change change the appearance, content, or appearance and content of the graphics in real time. Changes preferably can be specified through a same interface as used in step 21, graphics already displayed on an end-user device (e.g., as part of the interface), a different interface, or through some other device or system. Examples of possible permitted changes include but are not limited to adding text (e.g., in a chat context), adding graphics, moving at least a portion of the graphics, starting and stopping animations or the like, sending text or graphics to another user, making at least a portion of the graphics disappear or appear, changing a transparency level of at least a portion of the graphics, and the like.

In some embodiments, step 27 permits one user to at least partially specify changes to an appearance, content, or appearance and content of graphics to be mixed with a video stream for viewing by another user. Preferably, part of step 27 includes each user specifying which other users can specify changes to graphics for display on their own end user device.

By virtue of the foregoing operations, an appearance, content, or appearance and content of graphics mixed with a video stream for display to a user preferably can be responsive to input from that user, input from one or more other users, data associated with the video stream, data not associated with the video stream, or some combination thereof.

Method of Use

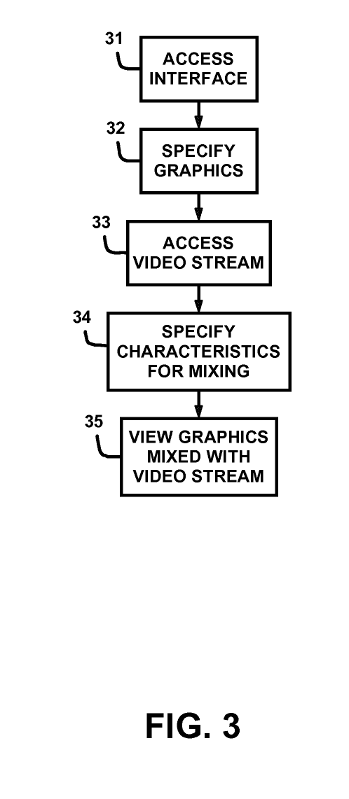

FIG. 3 is a flowchart illustrating implementation of one embodiment of the invention from a user's perspective. From that perspective, this embodiment permits a user to access an interface that permits at least partially specification of an appearance and content of graphics in step 30, to at least partially specify the appearance and content of the graphics using the interface in step 31, to access a video stream in step 32, to specify characteristics for mixing the graphics with the video stream in step 33, and to view the graphics mixed with the video stream on an end-user device in step 34 with a size and aspect ratio of the video stream unchanged. Various possible details of each of these steps correspond to the descriptions of the related steps discussed above.

Frames Illustration

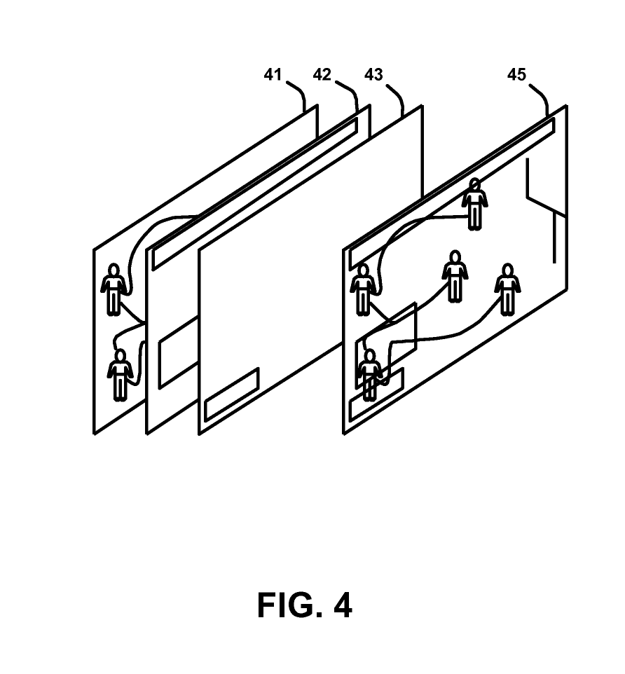

In one embodiment that can be implemented using the architecture and methods discussed above, the graphics stored in various buffers for mixing can be thought of as “frames.” FIG. 4 illustrates mixing of these frames. Thus, FIG. 4 shows video frame 41 from the video stream, application graphics frame 42 as specified wholly or partially by one or more users, and (optional) advertising frame 43 as specified wholly or partially by an advertiser.

The application graphics frame and/or advertising frame also can be responsive to content of the video stream, data associated with the video stream, or some other source. In a preferred embodiment, the application graphics and (optional) advertising are wholly or partially specified using Web 2.0 interfaces, although this need not be the case.

As shown in FIG. 4, the frames are mixed, preferably using alpha blending, resulting in output frame 45 for presentation to a user.

Application Examples

The foregoing architecture and methods enable a user to at least partially specify an appearance and select user-specific content for graphics to be mixed with a video stream (possibly accompanied by audio). This permits a user to personalize what graphics they see, how they see them, and display content that is specific to their own personal tastes. Several examples are discussed below. The invention includes but is not limited to these examples.

For one example, a user preferably can view personal fantasy game statistics while watching a sports television broadcast (in contrast to fantasy game statistics that the broadcaster might provide to the general audience of television viewers). Thus, one user preferably could view his or her personal game statistics through a small “ticker” at the top of a full-screen broadcast using a 50% transparency level, whereas a different user preferably could view his or her personal game statistics (which are different than the first user's statistics) through an alert “box” at the bottom left hand portion of the screen using an 80% transparency level. Preferably, each user can decide to change their mind and have the personal game statistics displayed using a different graphical user interface—or skin—and/or want to also move the application from one location to another and/or change the transparency ratio between the video stream and the application, and/or change the location of the application “on the fly” using an input device.

Other examples include permitting users to view multimedia retrieved from data providers, business servers or other user's computers while watching full-motion video. For example, users preferably can view, change, or add personal stock portfolio positions and prices, personal calendar or event alerts, personalized sports game statistics, other users' photos, other users' videos, and the like to full motion video. Still further examples include interacting with other users, such as voting on issues related to a web-based video or television broadcast, chatting with other users watching the broadcast, making wagers with other users, listening to alternative audio streams; watching complementary video streams or personalized commentary; and the like.

The graphics also preferably can be specified to be responsive to non-video and non-audio data contained in the video stream. For example, the graphics could be responsive to data in closed captioning, subtitles, or other streamed types of meta-data associated with a video stream. The graphics also preferably can be specified to be responsive to a source different from the video stream. For example, the graphics could be responsive to a different channel than that for the video stream, a local network, a remote network, the Internet, a wireless network, or some combination thereof.

The graphics need not be related to a specific video stream. For one example, the graphics could be one or more notes defined by a user that appear as sticky-notes, with the notes or presentation of the notes responsive to a date, time, or calendar. For another example, the graphics could be an associated application programming guide that provides suggestions of one or more applications to generate at least part of the graphics.

In the foregoing examples, a user preferably can keep the graphics/application displayed, but can change the television channel or video source at anytime without affecting the graphics/application. The user preferably also can change the graphics/application if so desired.

As noted above, the video stream in these examples preferably retains its size and aspect ratio when mixed with the graphics, or at least 75% of its size and aspect ratio when mixed with the graphics, in order to help preserve the entertainment value of the video stream itself.

Examples in Incorporated Disclosures

Various further specific examples of the invention are provided in the Incorporated Disclosures, including screenshots and code for some possible implementations. These examples include some more detailed versions of some of the examples discussed above, as well as other examples. The invention includes but is not limited to these examples.

Alternative Embodiments

While the foregoing discusses use of alpha-blending in the embodiments, applications, implementations, and examples, embodiments of the invention might use a different type of blending.

In the preceding description, a preferred embodiment of the invention is described with regard to preferred process steps and data structures. However, those skilled in the art would recognize, after perusal of this application, that embodiments of the invention may be implemented using one or more general purpose processors or special purpose processors adapted to particular process steps and data structures operating under program control, that such process steps and data structures can be embodied as information stored in or transmitted to and from memories (e.g., fixed memories such as DRAMs, SRAMs, hard disks, caches, etc., and removable memories such as floppy disks, CD-ROMs, data tapes, etc.) including instructions executable by such processors (e.g., object code that is directly executable, source code that is executable after compilation, code that is executable through interpretation, etc.), and that implementation of the preferred process steps and data structures described herein using such equipment would not require undue experimentation or further invention.

Furthermore, the invention is in no way limited to the specifics of any particular embodiments and examples disclosed herein. For example, the terms “preferably,” “preferred embodiment,” “one embodiment,” “this embodiment,” “alternative embodiment,” “alternatively” and the like denote features that are preferable but not essential to include in embodiments of the invention. The terms “comprising” or “including” mean that other elements and/or steps can be added without departing from the invention. In addition, single terms should be read to encompass plurals and vice versa (e.g., “user” encompasses “users” and the like). Many other variations are possible which remain within the content, scope and spirit of the invention, and these variations would become clear to those skilled in the art after perusal of this application.

What is claimed is:

1. A method comprising the steps of:
providing an interface that permits a user to at least partially specify an appearance and content of graphics;
generating the graphics;
accessing a video stream;
mixing the graphics with the video stream without changing a size and aspect ratio of the video stream; and
presenting the graphics mixed with the video stream to the user on an end-user device.

2. A method as in claim 1, further comprising the steps of:
buffering the graphics in an application graphics buffer; and
buffering the video stream in a video buffer;
wherein the step of mixing the graphics with the video stream further comprises mixing outputs from the application graphics buffer and the video buffer.

3. A method as in claim 2, wherein the step of mixing the outputs further comprises alpha-blending the outputs.

4. A method as in claim 1, wherein the graphics comprise one or more of data to be presented to the user, text, images, animation sequences, videos, video frames, tickers, static control features, interactive control features, or some combination thereof.

5. A method as in claim 1, wherein the graphics comprise a skin selected by the user.

6. A method as in claim 5, wherein the skin is selected from a library of skins that includes skins developed by people other than the user.

7. A method as in claim 1, further comprising the step of changing the appearance, the content, or the appearance and the content of the graphics in real time.

8. A method as in claim 7, wherein the appearance, the content, or the appearance and the content of the graphics are changed responsive to input from the user.

9. A method as in claim 7, wherein the appearance, the content, or the appearance and the content of the graphics are changed responsive to input from at least one person other than the user or from the user and at least one person other than the user.

10. A method as in claim 7, wherein changing the appearance, the content, or the appearance and the content of the graphics further comprises making at least a portion of the graphics disappear or appear.

11. A method as in claim 7, wherein changing the appearance, the content, or the appearance and the content of the graphics further comprises moving at least a portion of the graphics.

12. A method as in claim 7, wherein changing the appearance, the content, or the appearance and the content of the graphics further comprises changing a transparency level of at least a portion of the graphics.

13. A method as in claim 1, wherein the appearance, the content, or the appearance and the content of the graphics is responsive to non-video and non-audio data contained in the video stream.

14. A method as in claim 1, wherein the appearance, the content, or the appearance and the content of the graphics is responsive to a source different from the video stream.

15. A method as in claim 14, wherein the source is a different channel than that for the video stream, a local network, a remote network, the Internet, a wireless network, or some combination thereof.

16. A method as in claim 1, wherein the appearance and content of the graphics comprise one or more notes defined by a user that appear as sticky-notes, with the notes or presentation of the notes responsive to a date, time, or calendar.

17. A method as in claim 1, wherein the appearance and content of the graphics comprise an associated application programming guide that provides suggestions of one or more applications to generate at least part of the graphics.

18. A method as in claim 17, wherein one or more of the applications changes a source of the video stream.

19. A method of interactively viewing a video stream, comprising the steps of:
accessing an interface that permits a user to at least partially specify an appearance and content of graphics;
at least partially specifying the appearance and content of the graphics using the interface;
accessing the video stream;
specifying characteristics for mixing the graphics with the video stream; and
viewing the graphics mixed with the video stream on an end-user device;
wherein a size and aspect ratio of the video stream is unchanged by the steps of mixing and presenting.

20. A method as in claim 19, wherein the graphics comprise one or more of data to be presented to the user, text, images, animation sequences, videos, tickers, static control features, interactive control features, or some combination thereof.

21. A method as in claim 19, further comprising the step of selecting a skin for the graphics from a library of skins that includes skins developed by people other than the user.

22. A method as in claim 19, further comprising the step of specifying changes to the appearance, the content, or the appearance and the content of the graphics in real time.

23. A method as in claim 19, further comprising the step of permitting someone else to specify changes to the appearance, the content, or the appearance and the content of the graphics in real time.

24. A device comprising:
a processor and memory that executes an application to provide an interface that permits a user to at least partially specify an appearance and content of graphics and to generate the graphics;
an interface to a video stream;
an application graphics buffer that buffers the graphics;
a video buffer that buffers the video stream;
a mixer that mixes outputs from the application graphics buffer and the video buffer without changing a size and aspect ratio of the video stream; and
an interface to an end-user device for presentation of the graphics mixed with the video stream to the user.

25. A device as in claim 24, wherein the application accepts changes to the appearance, the content, or the appearance and the content of the graphics in real time.
